(19) United States
(12) Patent Application Publication
(10) Pub. No.: US 2025/0271619 A1
(43) Pub. Date: Aug. 28, 2025

(54) MULTICORE FIBER FAN-IN FAN-OUT DESIGN

(71) Applicant: Lumentum Operations LLC, San Jose, CA (US)

(72) Inventors: Jian CHEN, San Jose, CA (US); Chang XIAO, Shenzhen (CN); Fangdong ZHAO, Shenzhen (CN)

(21) Appl. No.: 19/055,634

(22) Filed: Feb. 18, 2025

(30) Foreign Application Priority Data
Feb. 28, 2024 (WO) PCTCN2024079153
May 14, 2024 (WO) PCTCN2024093008

(51) Int. Cl. G02B 6/32; G02B 6/02; G02B 6/26

(52) U.S. Cl. CPC G02B 6/327; G02B 6/02042; G02B 6/262

(57) ABSTRACT

An optical fiber system includes a multicore optical fiber including a first fiber cladding and a first plurality of fiber cores arranged within the first fiber cladding, including a first fiber core configured to guide a first signal light and a second fiber core configured to guide a second signal light; and a single-core fiber bundle comprising a plurality of single-core optical fibers arranged in a bundle. The plurality of single-core optical fibers includes a first single-core fiber comprising a second fiber cladding and a third fiber core arranged within the second fiber cladding, and a second single-core fiber comprising a third fiber cladding and a fourth fiber core arranged within the third fiber cladding. A pitch-to-core-size ratio of the single-core fiber bundle is equal or substantially equal to a pitch-to-core-size ratio of the multicore optical fiber.

### CROSS-REFERENCE TO RELATED APPLICATIONS

This patent application claims priority to Patent Cooperation Treaty (PCT) Patent Application No. PCT/CN2024/079153, filed on Feb. 28, 2024, and entitled “MULTICORE FIBER FAN-IN FAN-OUT DESIGN,” and Patent Cooperation Treaty (PCT) Patent Application No. PCT/CN2024/093008, filed on May 14, 2024, and entitled “MULTICORE FIBER FAN-IN FAN-OUT DESIGN.” The disclosures of the prior applications are considered part of and are incorporated by reference into this patent application.

### TECHNICAL FIELD

The present disclosure relates generally to optical fiber coupling systems.

### BACKGROUND

A multicore fiber (MCF) is a fiber containing two or more cores within a single strand. In other words, two or more cores are provided in a same fiber cladding. There is an issue of high insertion loss in MCF fan-in/fan-out devices arising from a mismatched pitch-to-core-size ratio between an MCF and single-core fiber bundle. A single-core fiber bundle is a bundle of two or more single-core fibers. A single-core fiber may also be referred to as a single-mode fiber (SMF). In scenarios involving free-space lens coupling between the MCF and the single-core fiber bundle, the insertion loss can exceed 3 dB (or a 50% loss), whereas a target maximum insertion loss is 0.2 dB (or a 4.5% loss).

### SUMMARY

In some implementations, an optical fiber system includes a multicore optical fiber including a first fiber cladding and a first plurality of fiber cores arranged within the first fiber cladding, wherein the first plurality of fiber cores includes a first fiber core configured to guide a first signal light and a second fiber core configured to guide a second signal light; a single-core fiber bundle comprising a plurality of single-core optical fibers arranged in a bundle, wherein the plurality of single-core optical fibers include: a first single-core fiber comprising a second fiber cladding and a third fiber core arranged within the second fiber cladding; and a second single-core fiber comprising a third fiber cladding and a fourth fiber core arranged within the third fiber cladding; and a fan-in and fan-out lens coupling system arranged between the multicore optical fiber and the single-core fiber bundle, wherein the fan-in and fan-out lens coupling system is configured to optically couple the first fiber core and the third fiber core along a first transmission path, and optically couple the second fiber core and the fourth fiber core along a second transmission path that crosses the first transmission path at a crossing point, wherein the fan-in and fan-out lens coupling system includes a first lens and a second lens, and the crossing point is located between the first lens and the second lens, and wherein a pitch-to-core-size ratio of the single-core fiber bundle is substantially equal to a pitch-to-core-size ratio of the multicore optical fiber.

In some implementations, an optical fiber system includes a multicore optical fiber including a first fiber cladding and a first plurality of fiber cores arranged within the first fiber cladding, wherein the first plurality of fiber cores includes a first fiber core configured to guide a first signal light and a second fiber core configured to guide a second signal light; a single-core fiber bundle comprising a plurality of single-core optical fibers arranged in a bundle, wherein the plurality of single-core optical fibers include: a first single-core fiber comprising a second fiber cladding and a third fiber core arranged within the second fiber cladding; and a second single-core fiber comprising a third fiber cladding and a fourth fiber core arranged within the third fiber cladding; and an optical coupling system arranged between the multicore optical fiber and the single-core fiber bundle, wherein the optical coupling system is configured to optically couple the first fiber core and the third fiber core along a first transmission path, and optically couple the second fiber core and the fourth fiber core along a second transmission path that crosses the first transmission path at a crossing point, wherein a pitch-to-core-size ratio of the single-core fiber bundle is substantially equal to a pitch-to-core-size ratio of the multicore optical fiber.

### BRIEF DESCRIPTION OF THE DRAWINGS

FIG. 1 shows an optical fiber system according to one or more implementations.

FIG. 2 shows an optical fiber system according to one or more implementations.

FIG. 3 shows an optical fiber system according to one or more implementations.

FIG. 4 shows an optical fiber system according to one or more implementations.

FIG. 5 shows an optical fiber system according to one or more implementations.

### DETAILED DESCRIPTION

The following detailed description of example implementations refers to the accompanying drawings. The same reference numbers in different drawings may identify the same or similar elements.

“Pitch” may refer to a distance from a core center of one fiber core to a core center of another fiber core (e.g., a core-to-core distance). “Core size” may refer to a diameter of a fiber core. “Pitch-to-core-size ratio” may refer to a ratio between the pitch and the core size (e.g., pitch:core size). There is an issue of high insertion loss in MCF fan-in/fan-out devices arising from a mismatched pitch-to-core ratio between an MCF and a single-core fiber bundle. The pitch-to-core-size ratio between the MCF and the single-core fiber bundle should be the same, to minimize insertion loss. For example, a core diameter of an MCF may be approximately 10 μm, similar to regular single-core fibers, with a core-to-core distance within the MCF of approximately 40 μm, resulting in the MCF having a pitch-to-core-size ratio of approximately 4:1. When single-core fibers are bundled together, the pitch-to-core-size ratio of the single-core fiber bundle may be approximately 12.5:1. Thus, there may be a significant mismatch between the pitch-to-core-size ratios of the MCF and the single-core fiber bundle that leads to high insertion loss.

Some implementations provide an optical fiber system in which a pitch-to-core-size ratio of a multicore optical fiber (e.g., an MCF) is matched or substantially matched (e.g., with a 10% tolerance) to a pitch-to-core-size ratio of a single-core fiber bundle. As a result, the optical fiber system may provide enhanced data transmission capacity in environments with limited fiber count. In some implementations, the MCF and the single-core fiber bundle are provided in an optical fiber system having a fan-in, fan-out configuration. The pitch-to-core-size ratio on a single-core fiber bundle side of the optical fiber system may be adjusted to align the pitch-to-core-size ratio with a pitch-to-core-size ratio of the MCF, and thereby eliminating losses caused by laser mode and aperture mismatch. The fan-in, fan-out configuration for free-space micro-optics coupling may be used to achieve low insertion loss.

To address a pitch-to-core-size ratio mismatch in the pitch-to-core-size ratios, claddings of single-core fibers of the single-core fiber bundle may be reduced such that the pitch-to-core-size ratio of the single-core fiber bundle is matched or substantially matched to the pitch-to-core-size ratio of the MCF. Alternatively, core sizes of the cores in each single-core fiber may be expanded such that the pitch-to-core-size ratio of the single-core fiber bundle is matched or substantially matched to the pitch-to-core-size ratio of the MCF. The core sizes of the cores in each single-core fiber may be expanded using thermal expansion core (TEC) technology. Thus, the re-sizes of the cores in each single-core fiber may be thermally-expanded fiber cores.

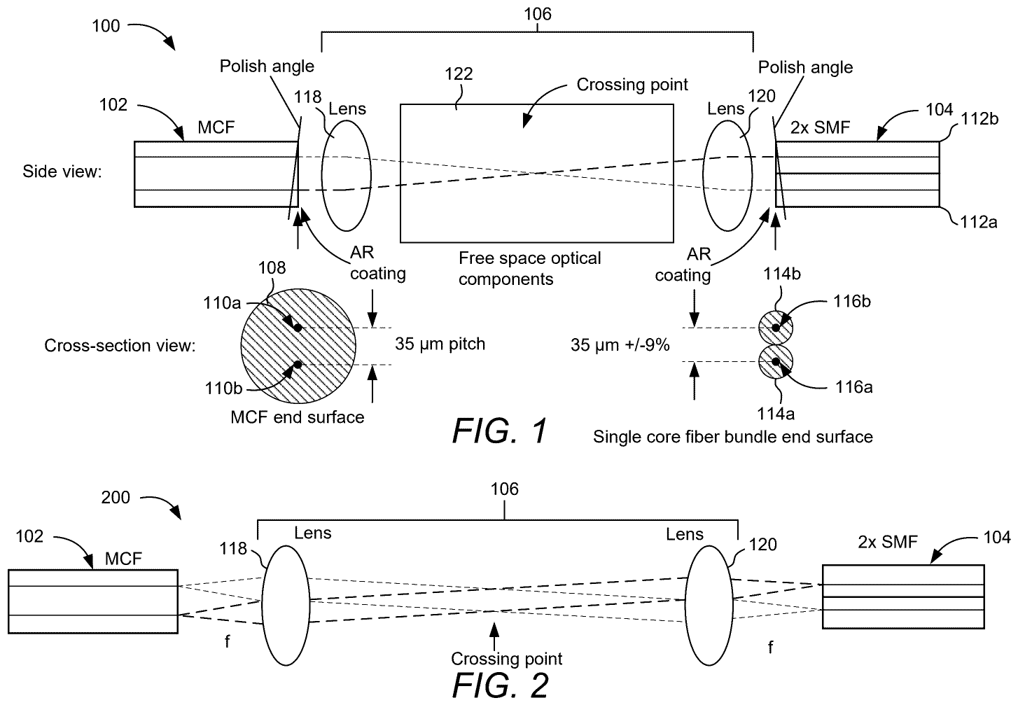

FIG. 1 shows an optical fiber system 100 according to one or more implementations. FIG. 1 shows a side view of the optical fiber system 100 and a cross-section view of end surfaces of optical fibers of the optical fiber system 100. The optical fiber system 100 may include an MCF 102 and a single-core fiber bundle 104 that is optically coupled to the MCF 102 by a coupling system 106.

In this example, optical fiber system 100 may be a two-core system. Thus, the MCF 102 may be a two-core MCF having two fiber cores arranged in a single cladding, with each fiber core configured to carry a respective optical signal (e.g., a respective light beam, such as a laser beam). The MCF 102 may include a first fiber cladding 108 and a first plurality of fiber cores 110 arranged within the first fiber cladding 108. The first plurality of fiber cores 110 may include a first fiber core 110a configured to guide a first signal light and a second fiber core 110b configured to guide a second signal light. In this example, the first plurality of fiber cores 110 may have a core size (e.g., a core diameter) of approximately 10 μm.

The single-core fiber bundle 104 may include a plurality of single-core optical fibers 112 (e.g., a plurality of SMFs) arranged in a bundle (e.g., 2× SMF). The plurality of single-core optical fibers 112 may include a first single-core fiber 112a that includes a second fiber cladding 114a and a third fiber core 116a arranged within the second fiber cladding 114a. The plurality of single-core optical fibers 112 may further include a second single-core fiber 112b that includes a third fiber cladding 114b and a fourth fiber core 116b arranged within the third fiber cladding 114b. The second fiber cladding 114a may be directly coupled (e.g., mechanically coupled) to the third fiber cladding 114b such that the first single-core fiber 112a and the second single-core fiber 112b are adjacent fibers within the single-core fiber bundle 104.

The diameters of the claddings (e.g., the second fiber cladding 114a and the third fiber cladding 114b) of each single-core optical fiber 112 may be reduced relative to a diameter of the first fiber cladding 108 of the MCF 102 such that a pitch between the two fiber cores 116 of the single-core fiber bundle 104 matches or substantially matches a pitch of the two fiber cores 110 of the MCF 102. For example, chemical etching may be used to reduce a fiber cladding size of each single-core optical fiber 112 in order to achieve a desired pitch-to-core-size ratio for the single-core fiber bundle 104. The first fiber cladding 108 may have a first cladding diameter dimension, and the second fiber cladding 114a and the third fiber cladding 114b may each have a second cladding diameter dimension that is smaller than the first cladding diameter dimension. As a result, the fiber cladding size of each single-core optical fiber 112 may be reduced such that a pitch-to-core-size ratio of the single-core fiber bundle 104 is matched or substantially matched (e.g., within a tolerance margin of 10%) to a pitch-to-core-size ratio of the MCF 102. A diameter of each fiber core in the MCF 102 and the single-core fiber bundle 104 may all be the same or substantially the same. For example, the two fiber cores 110 of the MCF 102 and the two fiber cores 116 of the single-core fiber bundle 104 may be equal to or substantially equal to 10 μm. As a result, each of the two optical signals (e.g., the first signal light and the second signal light) provided by the MCF 102 may be coupled into a respective core of the single-core fiber bundle 104 with low insertion loss. For example, each of the two optical signals may be coupled into a respective core of the single-core fiber bundle 104 with an insertion loss of 0.2 dB or less.

In an example, the first fiber core 110a and the second fiber core 100b may have a first core diameter dimension, and the first fiber core 110a and the second fiber core 100b may be separated by a first core-to-core distance (e.g., 35 μm pitch) in a transverse direction. The pitch-to-core-size ratio of the MCF 102 may be defined as a ratio of the first core-to-core distance to the first core diameter dimension. In addition, the third fiber core 116a and the fourth fiber core 116b may also have the first core diameter dimension, and the third fiber core 116a and the fourth fiber core 116b may be separated by a second core-to-core distance (e.g., 35 μm pitch +/−9%) in a transverse direction that is equal to or substantially equal to the first core-to-core distance. The pitch-to-core-size ratio of the single-core fiber bundle 104 may be defined as a ratio of the second core-to-core distance to the first core diameter dimension.

The coupling system 106 may be a fiber coupling system arranged between the MCF 102 and the single-core fiber bundle 104. The coupling system 106 may include free space optical components (e.g., free-space micro-optics), and therefore may be a free-space micro-optical coupler. In some implementations, the coupling system 106 may include a fan-in and fan-out lens coupling system that includes a first lens 118 and a second lens 120. Additionally, the coupling system 106 may include one or more free space optical components 122 that are arranged between the first lens 118 and the second lens 120. The free space optical components 122 may include an isolator core, a wavelength division multiplexing (WDM) filter, a tap filter, or other types of free space optical components.

The coupling system 106 may optically couple the first fiber core 110a and the fourth fiber core 116b along a first transmission path, and may optically couple the second fiber core 110b and the third fiber core 116a along a second transmission path that crosses the first transmission path at a crossing point that is located between the first lens 118 and the second lens 120. In other words, the first lens 118 may cause the first transmission path and the second transmission path to intersect at the crossing point. The second lens 120 may direct the first signal light provided from the first fiber core 110a into the third fiber core 116a, and may direct the second signal light provided from the second fiber core 110b into the fourth fiber core 116b. Thus, it may be said that the coupling system 106 causes the first signal light and the second signal light to “fan-in” and then “fan-out.”

In some implementations, the first lens 118 may be a focusing lens and the crossing point may correspond to a focal point of the first lens 118, and the second lens 120 may be a collimating lens.

In some implementations, the first lens 118 and the second lens 120 may be aspherical lenses. However, the first lens 118 and the second lens 120 may be any type of collimating lens, such as a gradient index (GRIN) lens, a C-lens, or a spherical lens.

The first lens 118 may receive the first signal light and the second signal light from the MCF 102, and direct the first signal light and the second signal light toward the second lens 120 on the first transmission path and the second transmission path, respectively. The second lens 120 may receive the first signal light and the second signal light from the first lens 118, couple the first signal light along the first transmission path into the third fiber core 116a, and couple the second signal light along the second transmission path into the fourth fiber core 116b.

The first lens 118 may receive the first signal light at a first point of incidence, and may receive the second signal light at a second point of incidence that is spatially separated from the first point of incidence by a distance corresponding to a pitch of the first fiber core 110a and the second fiber core 110b. The second lens 120 may receive the first signal light at a first point of incidence, and receive the second signal light at a second point of incidence that is spatially separated from the first point of incidence by a distance corresponding to a pitch of the third fiber core 116a and the fourth fiber core 116b.

As a result of the pitch-to-core-size ratio of the single-core fiber bundle 104 being matched or substantially matched (e.g., within a tolerance margin of 10%) to the pitch-to-core-size ratio of the MCF 102, the coupling system 106 may couple the first signal light into the fourth fiber core 116b with low insertion loss of 0.2 dB or less. Additionally, as a result of the pitch-to-core-size ratio of the single-core fiber bundle 104 being matched or substantially matched (e.g., within a tolerance margin of 10%) to the pitch-to-core-size ratio of the MCF 102, the coupling system 106 may couple the second signal light into the third fiber core 116a with low insertion loss of 0.2 dB or less.

In some implementations, the MCF 102 has a first fiber end coated with a first anti-reflective (AR) coating, the first single-core fiber 112a has a second fiber end coated with a second anti-reflective coating, and the second single-core fiber 112b has a third fiber end coated with a third anti-reflective coating. The first anti-reflective coating, the second anti-reflective coating, and the third anti-reflective coating may reduce insertion loss.

In some implementations, the MCF 102 may have a first fiber facet comprising a first polish angle configured to reduce back reflection, and the single-core fiber bundle 104 may have a second fiber facet comprising a second polish angle configured to reduce back reflection. For example, the first polish angle may be 8° and the second polish angle may be −8°. Thus, the first polish angle and the second polish angle may reduce insertion loss.

As indicated above, FIG. 1 is provided as an example. Other examples may differ from what is described with regard to FIG. 1. For example, the optical fiber system 100 may be an N-core system, where N is an integer greater than one. Thus, the MCF 102 and the single-core fiber bundle 104 may each have N cores.

FIG. 2 shows an optical fiber system 200 according to one or more implementations. FIG. 2 shows a side view of the optical fiber system 200. The optical fiber system 200 may be similar to the optical fiber system 100 described in connection with FIG. 1, with the exception that the first lens 118 and the second lens 120 are collimating lenses. Thus, the first signal light and the second signal light may be transmitted as collimated beams between the first lens 118 and the second lens 120 of the coupling system 106. A distance between the MCF 102 and the first lens 118 may correspond to a first focal length f of the first lens 118. A distance between the single-core fiber bundle 104 and the second lens 120 may correspond to a second focal length f of the second lens 120. The first focal length and the second focal length may be the same or different.

As indicated above, FIG. 2 is provided as an example. Other examples may differ from what is described with regard to FIG. 2.

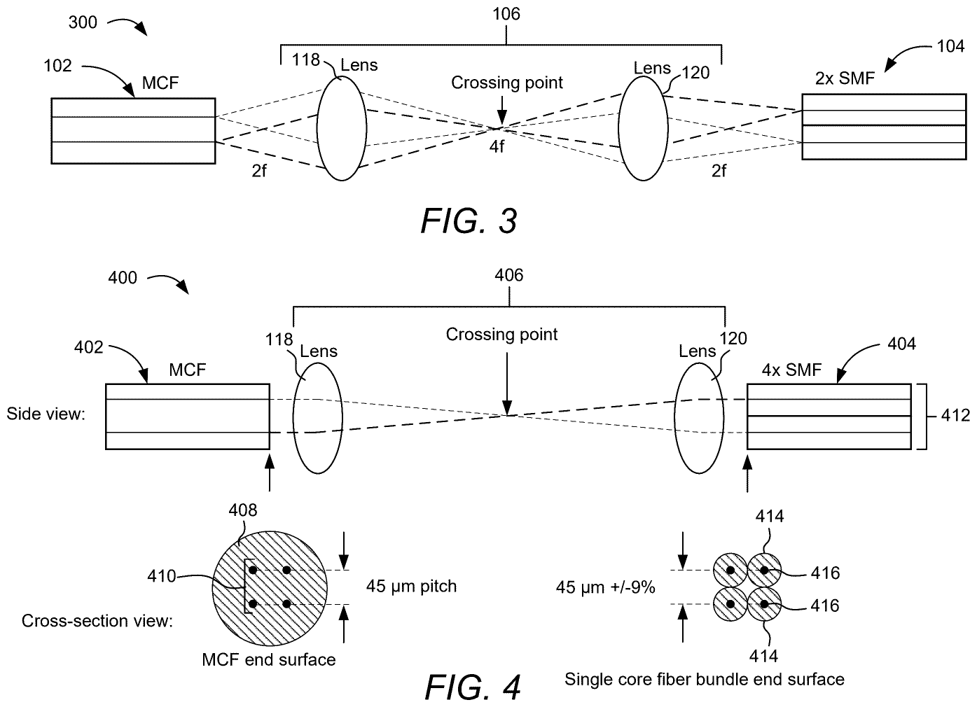

FIG. 3 shows an optical fiber system 300 according to one or more implementations. FIG. 3 shows a side view of the optical fiber system 300. The optical fiber system 300 may be similar to the optical fiber system 100 described in connection with FIG. 1, with the exception that the first lens 118 and the second lens 120 have different focal lengths on opposite sides of the lens (e.g., 2f and 4j).

As indicated above, FIG. 3 is provided as an example. Other examples may differ from what is described with regard to FIG. 3.

FIG. 4 shows an optical fiber system 400 according to one or more implementations. FIG. 4 shows a side view of the optical fiber system 400 and a cross-section view of end surfaces of optical fibers of the optical fiber system 400. The optical fiber system 400 may be similar to the optical fiber system 100 described in connection with FIG. 1, with the exception that N is equal to four. In other words, the optical fiber system 400 is a four-core system. Thus, the optical fiber system 400 includes an MCF 402 and the single-core fiber bundle 404 that each have four fiber cores. The single-core fiber bundle 404 may be optically coupled to the MCF 102 by a coupling system 406 that may be similar to coupling system 106.

In particular, the MCF 402 may be a four-core MCF having four fiber cores arranged in a single cladding, with each fiber core configured to carry a respective optical signal (e.g., a respective light beam, such as a laser beam). The MCF 102 may include a first fiber cladding 408 and a first plurality of fiber cores 410 arranged within the first fiber cladding 408.

The single-core fiber bundle 404 may include a plurality of single-core optical fibers 412 (e.g., a plurality of SMFs) arranged in a bundle (e.g., 4× SMF). The single-core fiber bundle 404 may include a plurality of second fiber claddings 414 and a second plurality of fiber cores 416. Each single-core optical fiber 412 may include a respective second fiber cladding 414 of the plurality of second fiber claddings 414, and a respective fiber core 416 of the second plurality of fiber cores 416.

The first plurality of fiber cores 410 and the second plurality of fiber cores 416 may each have a same or substantially same core diameter dimension (e.g., 10 μm). In addition, the second fiber claddings 414 may have a reduced diameter dimension relative to a diameter dimension of the first fiber cladding 408 of the MCF 402, such that a pitch between the two fiber cores 416 of the single-core fiber bundle 404 matches or substantially matches a pitch of two fiber cores 410 of the MCF 402. For example, the pitch of the two fiber cores 410 of the MCF 402 may be 45 μm, and the pitch between the two fiber cores 416 of the single-core fiber bundle 404 may be 45 μm +/−9%. The fiber cladding size of each single-core optical fiber 412 may be reduced such that a pitch-to-core-size ratio of the single-core fiber bundle 404 is matched or substantially matched (e.g., within a tolerance margin of 10%) to a pitch-to-core-size ratio of the MCF 402. The pitch-to-core-size ratios of the single-core fiber bundle 404 and the MCF 402 may be matched or substantially matched in both a vertical direction and a lateral direction. As a result, each of the four optical signals provided by the MCF 402 may be coupled into a respective core of the single-core fiber bundle 404 with low insertion loss. For example, each of the two optical signals may be coupled into a respective core of the single-core fiber bundle 404 with an insertion loss of 0.2 dB or less.

The coupling system 106 may optically couple two respective cores along a first transmission path, optically couple two other respective cores along a second transmission path, optically couple two other respective cores along a third transmission path, and optically couple two other respective cores along a fourth transmission path in a similar manner described in connection with FIG. 1. The first lens 118 may cause the first transmission path and the second transmission path to intersect at a first crossing point, and may cause the third transmission path and the fourth transmission path to intersect at a second crossing point. The second lens 120 may signal light into a respective fiber core 416 of the single-core fiber bundle 404.

While not shown, additional free-space optical components may be provided between the first lens 118 and the second lens 120.

As indicated above, FIG. 4 is provided as an example. Other examples may differ from what is described with regard to FIG. 4.

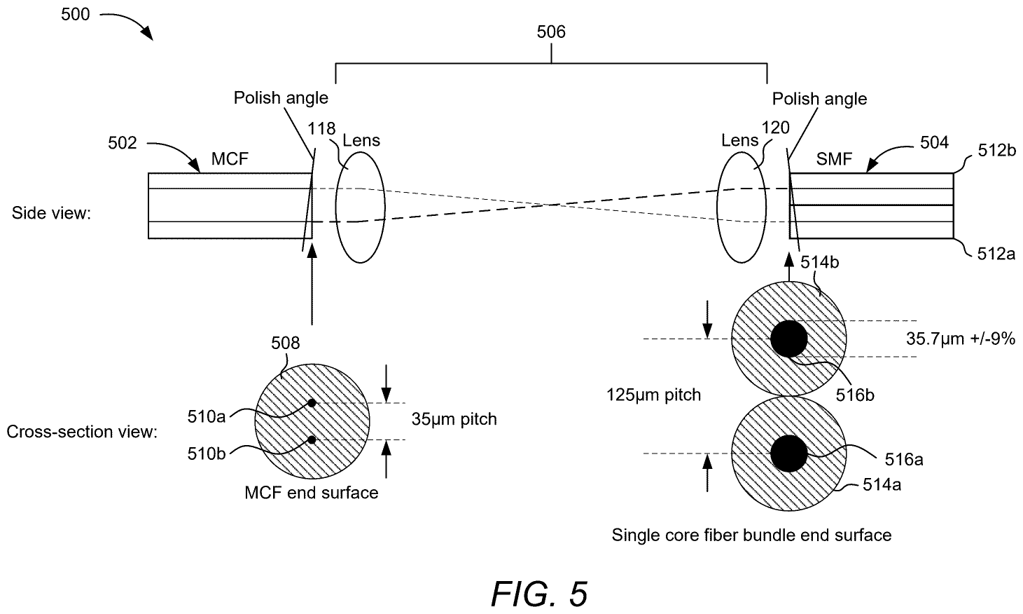

FIG. 5 shows an optical fiber system 500 according to one or more implementations. FIG. 5 shows a side view of the optical fiber system 500 and a cross-section view of end surfaces of optical fibers of the optical fiber system 500. The optical fiber system 500 may include an MCF 502 and a single-core fiber bundle 504 that is optically coupled to the MCF 502 by a coupling system 506 that may be similar to coupling system 106.

In this example, optical fiber system 500 may be a two-core system. Thus, the MCF 502 may be a two-core MCF having two fiber cores arranged in a single cladding, with each fiber core configured to carry a respective optical signal (e.g., a respective light beam, such as a laser beam). The MCF 502 may include a first fiber cladding 508 and a first plurality of fiber cores 510 arranged within the first fiber cladding 508. The first plurality of fiber cores 510 may include a first fiber core 510a configured to guide a first signal light and a second fiber core 510b configured to guide a second signal light. In this example, the first plurality of fiber cores 510 may have a first core size (e.g., a first core diameter) of approximately 10 μm.

The single-core fiber bundle 504 may include a plurality of single-core optical fibers 512 (e.g., a plurality of SMFs) arranged in a bundle. The plurality of single-core optical fibers 512 may include a first single-core fiber 512a that includes a second fiber cladding 514a and a third fiber core 516a arranged within the second fiber cladding 514a. The plurality of single-core optical fibers 512 may further include a second single-core fiber 512b that includes a third fiber cladding 514b and a fourth fiber core 516b arranged within the third fiber cladding 514b. The second fiber cladding 514a may be directly coupled (e.g., mechanically coupled) to the third fiber cladding 514b such that the first single-core fiber 512a and the second single-core fiber 512b are adjacent fibers within the single-core fiber bundle 504.

The first fiber cladding 508, the second fiber cladding 514a, and the third fiber cladding 514b may have a same or substantially same cladding diameter dimension. In addition, the first fiber core 510a and the second fiber core 510b may have a first core diameter dimension (e.g., approximately 10 μm), whereas the third fiber core 516a and the fourth fiber core 516b may have a second core diameter dimension (e.g., 35.7 μm +/−9%) that is larger than the first core diameter dimension. In some implementations, the third fiber core 516a and the fourth fiber core 516b may be thermally-expanded fiber cores. As a result, the first fiber core 510a and the second fiber core 510b are separated by a first core-to-core distance (or pitch) in a transverse direction (e.g., 35 μm), and the third fiber core 516a and the fourth fiber core 516b are separated by a second core-to-core distance (or pitch) in the transverse direction (e.g., 125 μm). The pitch-to-core-size ratio of the MCF 502 is defined as a ratio of the first core-to-core distance to the first core diameter dimension, and the pitch-to-core-size ratio of the single-core fiber bundle 504 is defined as a ratio of the second core-to-core distance to the second core diameter dimension. Due to the core sizes of the fiber cores 516 being different than (e.g., larger than) the core sizes of the fiber cores 510, a pitch-to-core-size ratio of the single-core fiber bundle 504 is equal or substantially equal to a pitch-to-core-size ratio of the MCF 502.

As a result of the pitch-to-core-size ratio of the single-core fiber bundle 504 being matched or substantially matched (e.g., within a tolerance margin of 10%) to the pitch-to-core-size ratio of the MCF 502, the coupling system 506 may couple the first signal light into the fourth fiber core 516b with low insertion loss of 0.2 dB or less. Additionally, as a result of the pitch-to-core-size ratio of the single-core fiber bundle 104 being matched or substantially matched (e.g., within a tolerance margin of 10%) to the pitch-to-core-size ratio of the MCF 502, the coupling system 506 may couple the second signal light into the third fiber core 516a with low insertion loss of 0.2 dB or less.

In some implementations, the MCF 502 has a first fiber end coated with a first anti-reflective coating, the first single-core fiber 512a has a second fiber end coated with a second anti-reflective coating, and the second single-core fiber 512b has a third fiber end coated with a third anti-reflective coating. The first anti-reflective coating and the second anti-reflective coating may reduce insertion loss.

In some implementations, the MCF 502 may have a first fiber facet comprising a first polish angle configured to reduce back reflection, and the single-core fiber bundle 504 may have a second fiber facet comprising a second polish angle configured to reduce back reflection. For example, the first polish angle may be 8° and the second polish angle may be −8°. Thus, the first polish angle and the second polish angle may reduce insertion loss.

As indicated above, FIG. 5 is provided as an example. Other examples may differ from what is described with regard to FIG. 5. For example, the optical fiber system 500 may be an N-core system, where N is an integer greater than one. Thus, the MCF 502 and the single-core fiber bundle 504 may each have N cores.

The following provides an overview of some Aspects of the present disclosure:

Aspect 1: An optical fiber system, comprising: a multicore optical fiber including a first fiber cladding and a first plurality of fiber cores arranged within the first fiber cladding, wherein the first plurality of fiber cores includes a first fiber core configured to guide a first signal light and a second fiber core configured to guide a second signal light; a single-core fiber bundle comprising a plurality of single-core optical fibers arranged in a bundle, wherein the plurality of single-core optical fibers include: a first single-core fiber comprising a second fiber cladding and a third fiber core arranged within the second fiber cladding; and a second single-core fiber comprising a third fiber cladding and a fourth fiber core arranged within the third fiber cladding; and a fan-in and fan-out lens coupling system arranged between the multicore optical fiber and the single-core fiber bundle, wherein the fan-in and fan-out lens coupling system is configured to optically couple the first fiber core and the third fiber core along a first transmission path, and optically couple the second fiber core and the fourth fiber core along a second transmission path that crosses the first transmission path at a crossing point, wherein the fan-in and fan-out lens coupling system includes a first lens and a second lens, and the crossing point is located between the first lens and the second lens, and wherein a pitch-to-core-size ratio of the single-core fiber bundle is equal or substantially equal to a pitch-to-core-size ratio of the multicore optical fiber.

Aspect 2: The optical fiber system of Aspect 1, wherein the first lens is a focusing lens and the crossing point corresponds to a focal point of the first lens, and wherein the second lens is a collimating lens.

Aspect 3: The optical fiber system of any of Aspects 1-2, wherein the first lens is configured to receive the first signal light and the second signal light from the multicore optical fiber, and direct the first signal light and the second signal light toward the second lens on the first transmission path and the second transmission path, respectively, and wherein the second lens is configured to receive the first signal light and the second signal light from the first lens, couple the first signal light along the first transmission path into the third fiber core, and couple the second signal light along the second transmission path into the fourth fiber core.

Aspect 4: The optical fiber system of Aspect 3, wherein the first lens is configured to receive the first signal light at a first point of incidence, and wherein the first lens is configured to receive the second signal light at a second point of incidence that is spatially separated from the first point of incidence by a distance corresponding to a pitch of the first fiber core and the second fiber core.

Aspect 5: The optical fiber system of Aspect 3, wherein the second lens is configured to receive the first signal light at a first point of incidence, and wherein the second lens is configured to receive the second signal light at a second point of incidence that is spatially separated from the first point of incidence by a distance corresponding to a pitch of the third fiber core and the fourth fiber core.

Aspect 6: The optical fiber system of any of Aspects 1-5, wherein the first lens and the second lens are aspherical lenses.

Aspect 7: The optical fiber system of any of Aspects 1-6, wherein first single-core fiber is arranged adjacent to the second single-core fiber in the single-core fiber bundle.

Aspect 8: The optical fiber system of any of Aspects 1-7, wherein the first fiber core and the second fiber core have a first core diameter dimension, wherein the first fiber core and the second fiber core are separated by a first core-to-core distance in a transverse direction, wherein the pitch-to-core-size ratio of the multicore optical fiber is defined as a ratio of the first core-to-core distance to the first core diameter dimension, wherein the third fiber core and the fourth fiber core have the first core diameter dimension, wherein the third fiber core and the fourth fiber core are separated by a second core-to-core distance in a transverse direction that is equal to the first core-to-core distance, and wherein the pitch-to-core-size ratio of the single-core fiber bundle is defined as a ratio of the second core-to-core distance to the first core diameter dimension.

Aspect 9: The optical fiber system of any of Aspects 1-8, wherein the first fiber core and the second fiber core have a first core diameter dimension, wherein the third fiber core and the fourth fiber core have a second core diameter dimension that is larger than the first core diameter dimension, wherein the first fiber core and the second fiber core are separated by a first core-to-core distance in a transverse direction, wherein the pitch-to-core-size ratio of the multicore optical fiber is defined as a ratio of the first core-to-core distance to the first core diameter dimension, wherein the third fiber core and the fourth fiber core are separated by a second core-to-core distance in a transverse direction that is larger than the first core-to-core distance, and wherein the pitch-to-core-size ratio of the single-core fiber bundle is defined as a ratio of the second core-to-core distance to the second core diameter dimension.

Aspect 10: An optical fiber system, comprising: a multicore optical fiber including a first fiber cladding and a first plurality of fiber cores arranged within the first fiber cladding, wherein the first plurality of fiber cores includes a first fiber core configured to guide a first signal light and a second fiber core configured to guide a second signal light; a single-core fiber bundle comprising a plurality of single-core optical fibers arranged in a bundle, wherein the plurality of single-core optical fibers include: a first single-core fiber comprising a second fiber cladding and a third fiber core arranged within the second fiber cladding; and a second single-core fiber comprising a third fiber cladding and a fourth fiber core arranged within the third fiber cladding; and an optical coupling system arranged between the multicore optical fiber and the single-core fiber bundle, wherein the optical coupling system is configured to optically couple the first fiber core and the third fiber core along a first transmission path, and optically couple the second fiber core and the fourth fiber core along a second transmission path that crosses the first transmission path at a crossing point, wherein a pitch-to-core-size ratio of the single-core fiber bundle is equal or substantially equal to a pitch-to-core-size ratio of the multicore optical fiber.

Aspect 11: The optical fiber system of Aspect 10, wherein the first fiber core and the second fiber core have a first core diameter dimension, wherein the first fiber core and the second fiber core are separated by a first core-to-core distance in a transverse direction, wherein the pitch-to-core-size ratio of the multicore optical fiber is defined as a ratio of the first core-to-core distance to the first core diameter dimension, wherein the third fiber core and the fourth fiber core have the first core diameter dimension, wherein the third fiber core and the fourth fiber core are separated by a second core-to-core distance in a transverse direction that is equal to the first core-to-core distance, and wherein the pitch-to-core-size ratio of the single-core fiber bundle is defined as a ratio of the second core-to-core distance to the first core diameter dimension.

Aspect 12: The optical fiber system of Aspect 11, wherein the first fiber cladding has a first cladding diameter dimension, wherein the second fiber cladding and the third fiber cladding have a second cladding diameter dimension that is smaller than the first cladding diameter dimension, and wherein the second fiber cladding is directly coupled to the third fiber cladding.

Aspect 13: The optical fiber system of Aspect 11, wherein first single-core fiber is arranged adjacent to the second single-core fiber in the single-core fiber bundle.

Aspect 14: The optical fiber system of any of Aspects 10-13, wherein the multicore optical fiber has a first fiber end coated with a first anti-reflective coating, the first single-core fiber has a second fiber end coated with a second anti-reflective coating, and the second single-core fiber has a third fiber end coated with a third anti-reflective coating.

Aspect 15: The optical fiber system of any of Aspects 10-14, wherein the multicore optical fiber has a first fiber facet comprising a first polish angle configured to reduce back reflection, and the single-core fiber bundle has a second fiber facet comprising a second polish angle configured to reduce back reflection.

Aspect 16: The optical fiber system of any of Aspects 10-15, wherein the first fiber core and the second fiber core have a first core diameter dimension, wherein the third fiber core and the fourth fiber core have a second core diameter dimension that is larger than the first core diameter dimension, wherein the first fiber core and the second fiber core are separated by a first core-to-core distance in a transverse direction, wherein the pitch-to-core-size ratio of the multicore optical fiber is defined as a ratio of the first core-to-core distance to the first core diameter dimension, wherein the third fiber core and the fourth fiber core are separated by a second core-to-core distance in a transverse direction that is larger than the first core-to-core distance, and wherein the pitch-to-core-size ratio of the single-core fiber bundle is defined as a ratio of the second core-to-core distance to the second core diameter dimension.

Aspect 17: The optical fiber system of Aspect 16, wherein the first fiber cladding, the second fiber cladding, and the third fiber cladding have a same cladding diameter dimension.

Aspect 18: The optical fiber system of Aspect 16, wherein the second fiber cladding is directly coupled to the third fiber cladding.

Aspect 19: The optical fiber system of Aspect 16, wherein first single-core fiber is arranged adjacent to the second single-core fiber in the single-core fiber bundle.

Aspect 20: The optical fiber system of Aspect 16, wherein the third fiber core and the fourth fiber core are thermally-expanded fiber cores.

Aspect 21: The optical fiber system of any of Aspects 10-20, wherein the optical coupling system includes one or more free space optical components.

Aspect 22: A system configured to perform one or more operations recited in one or more of Aspects 1-21.

Aspect 23: An apparatus comprising means for performing one or more operations recited in one or more of Aspects 1-21.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a dimension with an approximate dimension value may practically have a dimension within 5% of the approximate dimension value.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical fiber system, comprising:
a multicore optical fiber including a first fiber cladding and a first plurality of fiber cores arranged within the first fiber cladding, wherein the first plurality of fiber cores includes a first fiber core configured to guide a first signal light and a second fiber core configured to guide a second signal light;
a single-core fiber bundle comprising a plurality of single-core optical fibers arranged in a bundle, wherein the plurality of single-core optical fibers include:
a first single-core fiber comprising a second fiber cladding and a third fiber core arranged within the second fiber cladding; and
a second single-core fiber comprising a third fiber cladding and a fourth fiber core arranged within the third fiber cladding; and
a fan-in and fan-out lens coupling system arranged between the multicore optical fiber and the single-core fiber bundle, wherein the fan-in and fan-out lens coupling system is configured to optically couple the first fiber core and the third fiber core along a first transmission path, and optically couple the second fiber core and the fourth fiber core along a second transmission path that crosses the first transmission path at a crossing point,
wherein the fan-in and fan-out lens coupling system includes a first lens and a second lens, and the crossing point is located between the first lens and the second lens, and
wherein a pitch-to-core-size ratio of the single-core fiber bundle is substantially equal to a pitch-to-core-size ratio of the multicore optical fiber.

2. The optical fiber system of claim 1, wherein the first lens is a focusing lens and the crossing point corresponds to a focal point of the first lens, and
wherein the second lens is a collimating lens.

3. The optical fiber system of claim 1, wherein the first lens is configured to receive the first signal light and the second signal light from the multicore optical fiber, and direct the first signal light and the second signal light toward the second lens on the first transmission path and the second transmission path, respectively, and
wherein the second lens is configured to receive the first signal light and the second signal light from the first lens, couple the first signal light along the first transmission path into the third fiber core, and couple the second signal light along the second transmission path into the fourth fiber core.

4. The optical fiber system of claim 3, wherein the first lens is configured to receive the first signal light at a first point of incidence, and
wherein the first lens is configured to receive the second signal light at a second point of incidence that is spatially separated from the first point of incidence by a distance corresponding to a pitch of the first fiber core and the second fiber core.

5. The optical fiber system of claim 3, wherein the second lens is configured to receive the first signal light at a first point of incidence, and
wherein the second lens is configured to receive the second signal light at a second point of incidence that is spatially separated from the first point of incidence by a distance corresponding to a pitch of the third fiber core and the fourth fiber core.

6. The optical fiber system of claim 1, wherein the first lens and the second lens are aspherical lenses.

7. The optical fiber system of claim 1, wherein first single-core fiber is arranged adjacent to the second single-core fiber in the single-core fiber bundle.

8. The optical fiber system of claim 1, wherein the first fiber core and the second fiber core have a first core diameter dimension,
wherein the first fiber core and the second fiber core are separated by a first core-to-core distance in a transverse direction,
wherein the pitch-to-core-size ratio of the multicore optical fiber is defined as a ratio of the first core-to-core distance to the first core diameter dimension,
wherein the third fiber core and the fourth fiber core have the first core diameter dimension,
wherein the third fiber core and the fourth fiber core are separated by a second core-to-core distance in a transverse direction that is equal to the first core-to-core distance, and
wherein the pitch-to-core-size ratio of the single-core fiber bundle is defined as a ratio of the second core-to-core distance to the first core diameter dimension.

9. The optical fiber system of claim 1, wherein the first fiber core and the second fiber core have a first core diameter dimension,
wherein the third fiber core and the fourth fiber core have a second core diameter dimension that is larger than the first core diameter dimension,
wherein the first fiber core and the second fiber core are separated by a first core-to-core distance in a transverse direction,
wherein the pitch-to-core-size ratio of the multicore optical fiber is defined as a ratio of the first core-to-core distance to the first core diameter dimension,
wherein the third fiber core and the fourth fiber core are separated by a second core-to-core distance in a transverse direction that is larger than the first core-to-core distance, and
wherein the pitch-to-core-size ratio of the single-core fiber bundle is defined as a ratio of the second core-to-core distance to the second core diameter dimension.

10. An optical fiber system, comprising:
a multicore optical fiber including a first fiber cladding and a first plurality of fiber cores arranged within the first fiber cladding, wherein the first plurality of fiber cores includes a first fiber core configured to guide a first signal light and a second fiber core configured to guide a second signal light;
a single-core fiber bundle comprising a plurality of single-core optical fibers arranged in a bundle, wherein the plurality of single-core optical fibers include:
a first single-core fiber comprising a second fiber cladding and a third fiber core arranged within the second fiber cladding; and
a second single-core fiber comprising a third fiber cladding and a fourth fiber core arranged within the third fiber cladding; and
an optical coupling system arranged between the multicore optical fiber and the single-core fiber bundle, wherein the optical coupling system is configured to optically couple the first fiber core and the third fiber core along a first transmission path, and optically couple the second fiber core and the fourth fiber core along a second transmission path that crosses the first transmission path at a crossing point,
wherein a pitch-to-core-size ratio of the single-core fiber bundle is substantially equal to a pitch-to-core-size ratio of the multicore optical fiber.

11. The optical fiber system of claim 10, wherein the first fiber core and the second fiber core have a first core diameter dimension,
wherein the first fiber core and the second fiber core are separated by a first core-to-core distance in a transverse direction,
wherein the pitch-to-core-size ratio of the multicore optical fiber is defined as a ratio of the first core-to-core distance to the first core diameter dimension,
wherein the third fiber core and the fourth fiber core have the first core diameter dimension,
wherein the third fiber core and the fourth fiber core are separated by a second core-to-core distance in a transverse direction that is equal to the first core-to-core distance, and
wherein the pitch-to-core-size ratio of the single-core fiber bundle is defined as a ratio of the second core-to-core distance to the first core diameter dimension.

12. The optical fiber system of claim 11, wherein the first fiber cladding has a first cladding diameter dimension,
wherein the second fiber cladding and the third fiber cladding have a second cladding diameter dimension that is smaller than the first cladding diameter dimension, and
wherein the second fiber cladding is directly coupled to the third fiber cladding.

13. The optical fiber system of claim 11, wherein first single-core fiber is arranged adjacent to the second single-core fiber in the single-core fiber bundle.

14. The optical fiber system of claim 10, wherein the multicore optical fiber has a first fiber end coated with a first anti-reflective coating, the first single-core fiber has a second fiber end coated with a second anti-reflective coating, and the second single-core fiber has a third fiber end coated with a third anti-reflective coating.

15. The optical fiber system of claim 10, wherein the multicore optical fiber has a first fiber facet comprising a first polish angle configured to reduce back reflection, and the single-core fiber bundle has a second fiber facet comprising a second polish angle configured to reduce back reflection.

16. The optical fiber system of claim 10, wherein the first fiber core and the second fiber core have a first core diameter dimension,
wherein the third fiber core and the fourth fiber core have a second core diameter dimension that is larger than the first core diameter dimension,
wherein the first fiber core and the second fiber core are separated by a first core-to-core distance in a transverse direction,
wherein the pitch-to-core-size ratio of the multicore optical fiber is defined as a ratio of the first core-to-core distance to the first core diameter dimension,
wherein the third fiber core and the fourth fiber core are separated by a second core-to-core distance in a transverse direction that is larger than the first core-to-core distance, and
wherein the pitch-to-core-size ratio of the single-core fiber bundle is defined as a ratio of the second core-to-core distance to the second core diameter dimension.

17. The optical fiber system of claim 16, wherein the first fiber cladding, the second fiber cladding, and the third fiber cladding have a same cladding diameter dimension.

18. The optical fiber system of claim 16, wherein the second fiber cladding is directly coupled to the third fiber cladding.

19. The optical fiber system of claim 16, wherein first single-core fiber is arranged adjacent to the second single-core fiber in the single-core fiber bundle.

20. The optical fiber system of claim 16, wherein the third fiber core and the fourth fiber core are thermally-expanded fiber cores.

21. The optical fiber system of claim 10, wherein the optical coupling system includes one or more free space optical components.
